(19) United States
(12) Patent Application Publication
(10) Pub. No.: US 2005/0204581 A1
(43) Pub. Date: Sep. 22, 2005

(54) Drying section for a papermaking machine and associated apparatus and method

(75) Inventor: Dennis Edward Jewitt, St. Mary's Platt (GB)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Metso Paper Karlstad Aktiebolag (AB)

(21) Appl. No.: 10/937,029

(22) Filed: Sep. 9, 2004

Related U.S. Application Data
(60) Provisional application No. 60/554,863, filed on Mar. 19, 2004.

(51) Int. Cl. F26B 3/00; D21J 1/00

(52) U.S. Cl. 34/453; 162/290

(57) ABSTRACT

A drying section for a papermaking machine includes an initial dryer having a rotatable through-air drying cylinder for providing initial drying of a wet paper web entering the drying section, and a fabric for receiving the web. The fabric is configured to receive the web at a web receiving point. and to advance the web at least partially about the cylinder in a rotational direction from an inlet to an outlet, the angular distance between the inlet and the outlet defining a wrap angle. A roll disposed adjacent to the cylinder defines the inlet. The roll is also disposed upstream with respect to the rotational direction from a tangent to the cylinder, wherein the tangent is defined by an engagement between the fabric and the cylinder absent the roll, to increase the wrap angle about the cylinder with respect to the tangent. Associated apparatuses and methods are also provided.

### CROSS-REFERENCE TO RELATED APPLICATIONS

This application claims the benefit of U.S. Provisional Application No. 60/554,863, filed Mar. 19, 2004.

### BACKGROUND OF THE INVENTION

1. Field of the Invention

The present invention relates to papermaking machines and, more specifically, to a drying section for a papermaking machine and associated apparatus and method.

2. Description of Related Art

A papermaking machine typically includes a forming section for forming a relatively wet paper web. The web may be formed on a forming wire and then transferred to a fabric configured to transport the web to a drying section, the drying section having one or more drying devices for the drying the web. Sometimes, however, the web may be formed directly on the fabric and then transported by the fabric to the drying section. With either web forming method, a compact papermaking machine is generally configured such that the web is formed in close proximity to the initial drying device in the drying section. The newly-formed and relatively wet web is typically fragile, but tends to increase in strength as it is dried. Accordingly, the web must initially be carefully handled.

In some instances, the drying device may comprise a through-air dryer (TAD) where the fabric supporting the web wraps at least partially about the circumference or shell of a perforated rotatable cylinder. At the same time, air or another drying medium is directed through the web and the fabric so as to dry the web. That portion of the circumference of the cylinder engaging the web/fabric is usually covered by a hood for providing the drying air or receiving the exhaust air. An inward flow TAD is provided when the air flows from the hood and through the perforations into the interior or the cylinder. In such a configuration, the web is separated from contact with the cylinder by the fabric. Accordingly, in light of the fragile nature of the relatively wet web, where the initial drying device in the drying section is an inward flow TAD employing a single fabric, the fabric is generally directed to engage the cylinder of the TAD at a tangent with respect to the rotational direction of the cylinder. One reason for doing so is to avoid contact with the web prior to the web being dried, for example, to at least about 40% to 50% dry solids content. Such dryness of the web generally cannot be achieved with the described papermaking machine configuration prior to the initial drying device.

One limitation with the tangential engagement between the fabric and the TAD cylinder is that the wrap angle of the fabric about the circumference of the TAD cylinder is restricted. That is, the tangential engagement configuration results in a relatively large portion of the circumference of the TAD cylinder that is not engaged by the fabric during the drying process, otherwise known as the dead zone. In some instances, however, the fabric and the web may be directed through an outlet nip formed between the TAD cylinder and an adjacent roll on the downstream side of the TAD. Such a configuration is shown, for example, in FIGS. 1 and 2 of U.S. Pat. No. 6,398,916 to Klerelid. For a single fabric, inward flow TAD, the outlet nip necessarily means that the web contacts the roll upon exiting the TAD. Such contact may be acceptable since the web has been at least partially dried by the TAD prior to the outlet nip. The outlet nip may be disposed further along in the rotational direction of the TAD cylinder, as compared to the fabric leaving the TAD cylinder at a tangent, which serves to increase the wrap angle of the fabric about the TAD cylinder. However, the extent to which the roll may be moved in the rotational direction is limited due to, for example, the location of the next process in papermaking procedure, the maximum wrap angle about the roll that will not adversely affect the web and/or the fabric, and the extent to which the hood can be extended to cover the fabric through the wrap angle without adversely affecting the air flow and/or other performance characteristics of the hood.

For a certain flow, humidity, and temperature of the drying medium through the hood, and the rotational speed and diameter of the cylinder, the wrap angle of the fabric about the TAD cylinder (and, in some cases, characteristics of the web and the fabric) generally determines the amount of drying of the web provided by the TAD. As such, for a particular TAD configuration, there are limited manners in which the amount of drying provided by the TAD can be increased, where such methods often have associated limitations. For example, the rotational speed of the cylinder is usually related to the overall processing speed of the papermaking machine and, as such, usually cannot be greatly varied without affecting other processes or the production rate. Thus, is would be generally undesirable to reduce the rotational speed of the TAD cylinder in order to gain an increased drying amount, since that would, in turn, decrease the production rate. Another method of increasing the amount of drying provided by the TAD is to increase the air flow through the web. However, increased air flow is typically associated with energy costs associated with providing that increased air flow. That is, since the pressure drop across the web also tends to increase with the increased air flow, larger fans are also required in order to overcome the increased resistance and to supply the additional flow of drying medium. As such, this method may also be undesirable.

Yet another method for increasing the amount of drying increase is to increase the temperature of the drying medium supplied to the web. However, the increased temperature may result in damage to or reduced service life of the fabric and, in some instances, may result in an objectionable odor in the web. Still another method for increasing the amount of drying is to increase the diameter of the TAD cylinder. However, increased TAD cylinder size may also be undesirably associated with increased fabrication costs for the cylinder and other systems associated with the bigger TAD, as well as the building necessary to house the larger machine. The available increase in TAD cylinder size may also be limited in retrofit situations where existing space may be limited. Yet another option is to provide a second successive TAD. However, such an option may also be undesirable in terms of cost and space limitations. Both the larger TAD cylinder and the additional TAD options may also undesirably result in a physically larger machine.

U.S. Pat. No. 3,432,936 to Cole et al. uses the approach of installing a Yankee dryer as the initial dryer in the drying section. In this manner, the formed web is first transferred directly onto the cylinder of the Yankee dryer and, after being dried by the Yankee dryer, the web is creped from the cylinder by a doctor blade. Thereafter, the web is directed to a through-air dryer for further drying. In directing the web to the TAD, the web travels about a roll between the Yankee dryer and the TAD, which tends to increase the wrap angle of the web about the TAD cylinder, compared to the web tangentially engaging the TAD cylinder. As such, an increased amount of drying of the web may be obtained with such a machine. However, this web-contacting roll engages the web after the web has been dried by the Yankee dryer and, as such, the TAD is not the initial dryer in the drying section. As a result, a physically larger drying section/papermaking machine is obtained and associated costs of such a machine are higher, compared to a drying section/papermaking machine without a Yankee dryer. An additional dryer also increases the amount of handling of the web and, as such, increases the risk of damage to the web during the papermaking process.

Still further, the drying and creping processes associated with the Yankee dryer may produce a web with characteristics not desired in the final product, even though the web is subsequently dried by a TAD. For example, the Cole '936 patent describes a process in which the web is directed through a press nip and then a second nip against the cylinder of the Yankee dryer, before the web is dried by the Yankee dryer and creped. Accordingly, the formed web is first compressed by the press nip and the second nip before being dried by the Yankee dryer, creped, and further dried by the TAD. The web is therefore pre-dried by the Yankee dryer prior to a molding process, typically performed on the web prior to the web being dried by the TAD. Thus, such a compression and pre-drying process typically inhibits bulk generation in the web and thereby tends to produce a relatively low bulk/high density tissue, which may sometimes be referred to as a “conventional tissue.” In contrast, a web dried by a TAD process only, or a web initially dried by a TAD process followed by a Yankee dryer, is typically not compressed prior to initial drying by the TAD. Accordingly, a web initially dried by a TAD may be characterized by a relatively high bulk and lower density. Such a tissue initially dried by a TAD may also exhibit a higher resistance to degradation when wetted and, as such, may be characterized by a relatively high absorbency. Both of the described processes may be adjusted, however, so as to result in similar tensile strengths of the dried webs. The web dried by the Yankee dryer/TAD combination disclosed in the Cole '936 patent may have characteristics, such as tactile quality, that may be distinctly different from a web initially dried by a TAD.

Drying sections/papermaking machines employing a TAD as the initial dryer in the drying section, for example, as shown in FIGS. 1 and 2 of the Klerelid '916 patent, may increase the wrap angle about the TAD by moving the web receiving point against the direction of rotation of the TAD cylinder so as to affect the location of the tangential engagement between the fabric and the TAD cylinder. Such a method, however, may be limited by, for example, the configuration of the former and the manner in which the newly formed web can be transferred to the fabric. In instances where the inward flow TAD is configured with the hood below the cylinder, the web is generally directed to the TAD cylinder from above. One consequence is that the former or forming section may have to be raised above the level of the TAD to provide an appropriate configuration for transferring the web to the fabric such that the fabric can tangentially engage the TAD cylinder to provide a sufficient wrap angle. The height of the web receiving point may also be affected by process components that must be placed between the web receiving point and the TAD such as, for example, a web transfer device (vacuum box) or molding box. The raised former may thus be undesirable with respect to the resulting increased height or increased size of the drying section/papermaking machine. A physically larger building may also be required to house such a machine, while the raised nature of the former may also limit access to the former, as well as other components between the former and the TAD such as vacuum boxes or imprinting devices, by maintenance personnel.

Another result of the raised web receiving point, in instances where the inward flow TAD is configured with the hood below the cylinder, as previously discussed, is that the web is typically transported substantially vertically downward into engagement with the TAD. As a result, during normal operation of the papermaking machine, loose web or fabric fibers from trim squirts or tail cutting processes may be transported by gravity or other mechanisms to collect in the TAD (inside the hood) or on the hood surrounding the TAD cylinder as undesirable contaminants. Contamination of the TAD cylinder or hood may also be significant in instances of web breaks. The TAD cylinder, hood, and possibly the web may also be susceptible to contamination from, for example, water shed from the fabric and/or the web as the web is transferred from the forming fabric and transported by the fabric to the TAD cylinder. Further, an inward flow TAD configured for tangential engagement with the fabric transporting the web may also be difficult to seal since the fabric is unsupported at the entrance to the TAD. This lack of support for the fabric at the entrance to the TAD may also undesirably cause the point of contact between the fabric and the cylinder to vary and flutter due to lack of stability. Since such a TAD may be difficult to seal, energy efficiency may be adversely affected since drying air may be lost due to leaks and leaking exhaust air may result in rewetting of the web and/or fabric. In addition, the drying air leaking from the hood can also cause unpleasant working conditions in and around the TAD and, as such, additional room ventilation may sometimes be required.

Thus, there exists a need for an apparatus and method for increasing the amount of drying provided by a drying section in which a TAD is the initial dryer, while minimizing the handling and/or risk of damage to the web, and providing the desired characteristics in the dried web. Such a solution should desirably be accomplished without requiring elaborate and expensive equipment, while maintaining or decreasing the size, height, or other dimensions of the drying section/papermaking machine. It may also be desirable for the solution to provide increased energy efficiency by, for example, increased drying for a comparable configuration or by allowing improved sealing. In addition, such a solution should desirably provide accessible and maintenance-friendly componentry. It may also be desirable for the solution to be applicable to new construction, as well as retrofit situations.

### BRIEF SUMMARY OF THE INVENTION

The above and other needs are met by the present invention which, in one embodiment, provides a drying section for a papermaking machine. Such a drying section includes an initial dryer adapted to provide initial drying of a wet paper web entering the drying section, wherein the initial dryer comprises a drying cylinder rotatable in a rotational direction. A fabric is configured to receive the web at a web receiving point and to advance the web at least partially about the cylinder over an angular distance in the rotational direction from an inlet to an outlet. The angular distance between the inlet and the outlet defines a wrap angle of the fabric. An inlet roll is disposed adjacent to the cylinder so as to define the inlet. The inlet roll is further disposed upstream, with respect to the rotational direction, from a tangent to the cylinder, wherein the tangent is defined by an engagement between the fabric and the cylinder, absent the inlet roll. Accordingly, the inlet roll increases the wrap angle of the fabric about the cylinder of the initial dryer with respect to the tangent.

Another advantageous aspect of the present invention comprises a drying section for a papermaking machine. Such a drying section includes a fabric adapted to support a wet paper web and an initial drying cylinder rotatable in a rotational direction, the initial drying cylinder being configured to have the fabric advanced at least partially thereabout. A hood is configured to surround at least a portion of the cylinder engaging the fabric and to provide an inward air flow with respect to the cylinder, wherein the hood has a contoured profile configured to direct a substantially even air flow into the cylinder along the portion of the cylinder covered by the hood.

Still another advantageous aspect of the present invention comprises a method of drying a wet paper web in a drying section of a papermaking machine. A fabric supporting the wet paper web is directed toward an initial dryer configured to provide initial drying of the web upon the web entering the drying section. The initial dryer comprises a drying cylinder rotatable in a rotational direction. The web and the fabric are then advanced at least partially about the cylinder over an angular distance in the rotational direction from an inlet to an outlet, wherein the angular distance between the inlet and the outlet defines a wrap angle of the fabric. Prior to the web and fabric being advanced about the cylinder, the web and the fabric are advanced through the inlet prior, the inlet being defined by a web-contacting inlet roll disposed adjacent to the cylinder and upstream, with respect to the rotational direction, from a tangent to the cylinder. The tangent is defined by an engagement between the fabric and the cylinder absent web-contacting inlet roll. The inlet provided by the web-contacting inlet roll thereby increases the wrap angle of the fabric about the cylinder with respect to the tangent.

As such, embodiments of the present invention provide a conditioning section in which the cleaning and/or showering processes are laterally separated from a final dewatering element, such as a vacuum box, thereby reducing or eliminating the need for sealing of the cleaning elements, rewetting of the fabric exiting the conditioning section, and power consumption by the vacuum box or other final dewatering element. Thus, embodiments of the present invention provide significant advantages as further detailed herein.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic illustration of a drying section of a papermaking machine implementing a sheet-side inlet roll in a cross-flow through-air dryer according to one embodiment of the present invention;

FIG. 2 is a schematic illustration of a drying section of a papermaking machine employing a cross-flow through-air dryer according to an alternate embodiment of the present invention;

FIGS. 3-4 are schematic illustrations of a drying section of a papermaking machine implementing a sheet-side inlet roll in a cross-flow through-air dryer according to alternate embodiments of the present invention;

FIG. 5 is a schematic illustration of a drying section of a papermaking machine implementing successive cross-flow through-air dryers with corresponding hoods defining a gutter therebetween, and a fabric-conditioning apparatus for cleaning the through-air drying fabric, according to one embodiment of the present invention;

FIG. 6 is a schematic illustration of a through-air dryer implementing a contoured hood according to one embodiment of the present invention;

FIGS. 7 and 8 are schematic illustrations of an exhaust plenum configured to extend between the inlet and outlet rolls of a cross-flow through-air dryer, and seals therefore, according to one embodiment of the present invention; and

FIGS. 9 and 10 are schematic illustrations of cross-machine plenum seals for an exhaust plenum configured to extend between the inlet and outlet rolls of a cross-flow through-air dryer, according to alternate embodiments of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

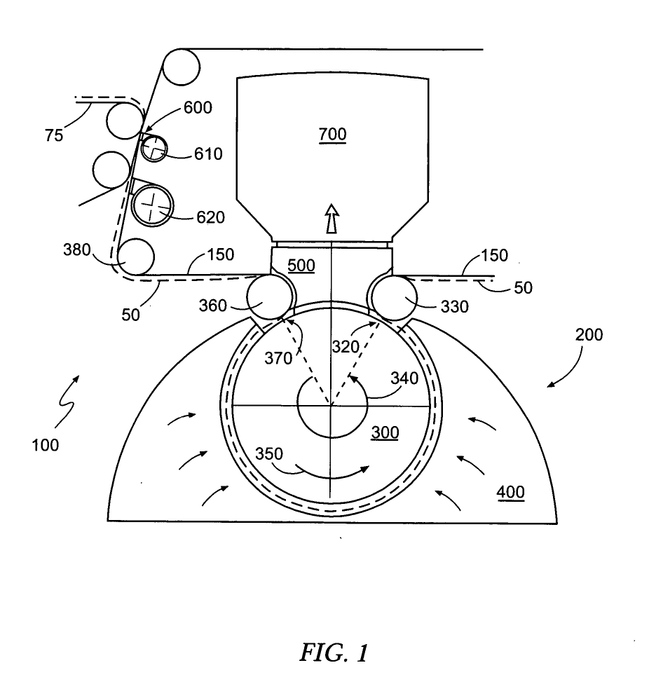

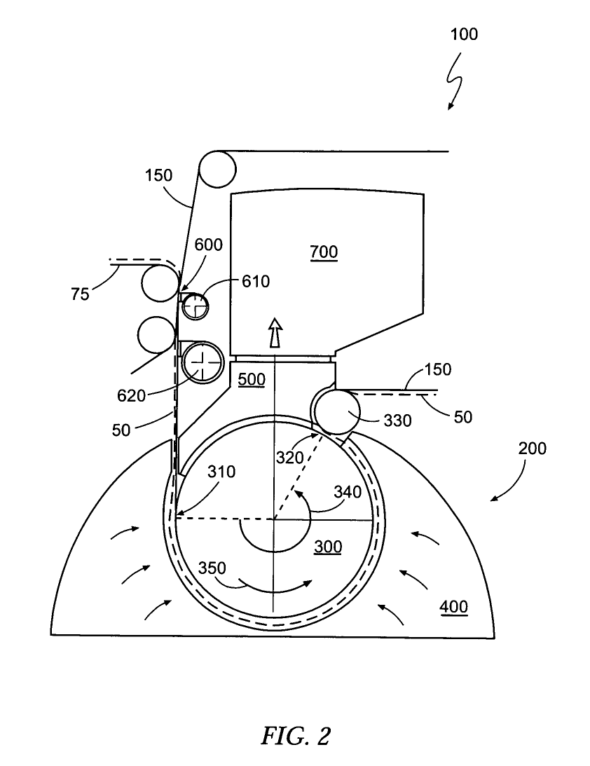

FIG. 1 illustrates a drying section according to one embodiment of the present invention, the drying section being generally indicated by the numeral 100. In one embodiment, the drying section 100 includes one or more through-air dryers (TADs) 200. A TAD generally comprises a perforated rotatable drying cylinder 300. A fabric 150, which may be configured as a through-air drying (TAD) fabric formed in a loop, supports and transports a wet paper web 50 at least partially about the shell or circumference of the cylinder 300 in a direction of rotation 350. Each cylinder 300 includes a hood 400 at least partially surrounding the cylinder 300, more particularly, the portion of the shell or circumference of the cylinder 300 engaged by the TAD fabric 150. The TAD 200 may be configured as an inward flow TAD or an outward flow TAD. With respect to an inward flow TAD 200, as illustrated in one embodiment as shown in FIG. 2, the hood 400 is disposed and configured to provide an air flow to the cylinder 300, where the air flow is directed through the web 50 and the fabric 150, and into the interior of the cylinder 300 through the perforations. In an inward flow TAD configuration, the web 50 is separated from the cylinder 300 by the fabric 150. One skilled in the art will appreciate, however, that the web 50 may, in some instances of an inward flow TAD, be sandwiched between two TAD fabrics (not shown) such that the air flow provided by the hood 400 passes through an additional TAD fabric before passing through the web 50 and the initial TAD fabric 150 and entering the interior of the cylinder 300 through the perforations.

The air flow or exhaust air entering the cylinder 300 includes moisture removed from the web 50. Accordingly, this moisture-laden exhaust air must be removed from the cylinder 300 and/or the drying section 100 in order to avoid rewetting the web 50. In one embodiment of the present invention, the exhaust air may be removed, for example, axially along the cylinder 300. In another embodiment of the present invention, the TAD 200 may be configured as cross-flow TAD, wherein the exhaust air is removed from the cylinder 300 via an exhaust plenum 500 configured to cooperate with the cylinder 300 about the portion of the cylinder 300 not engaged with the fabric 150. That is, since the fabric 150 wraps only partially about the cylinder 300, there remains a sector or portion of the cylinder 300 (which may also be known as a dead zone) that, at any time, is not contacted by the fabric 150 transporting the web 50. Thus, in the cross-flow TAD configuration, the exhaust air may be removed through the perforations in the cylinder 300 about the dead zone and gathered by the exhaust plenum 500 in order to, for example, remove the exhaust air from the drying section 100 or to process the exhaust air (i.e. remove the moisture in the exhaust air) such that the air may be recycled through the TAD 200 or elsewhere in the web drying process. In an axial flow configuration, the exhaust air is removed from the cylinder 300 through one or both of the ends thereof.

In a through-air drying process, the web 50 is generally received by the TAD fabric 150 at a web receiving point 600, wherein, for example, the web 50 may be transferred to the TAD fabric 150 from a forming section (not shown) or formed directly on the TAD fabric 150, as will be appreciated by one skilled in the art. In instances where the web 50 is transferred to the TAD fabric 150 such as, for instance, from a forming wire 75, the drying section 100 may include a transfer device 610 disposed within the loop of the TAD fabric 150 for facilitating transfer of the web 500 from the forming wire 75 to the TAD fabric 150. The transfer device 610 may comprise, for example, a suction device or other suitable device. Following the transfer device 610, a molding device 620 may also be disposed within the loop of the TAD fabric 150. Due to the wet nature of the web 50 following the transfer device 610 (and the molding device 620, where used), the web 50 is typically transported directly to the cylinder 300 of the initial TAD 200 by the fabric 150. The fabric 150 then engages the cylinder 300 at a tangent 310 thereto in the rotational direction 350 of the cylinder 300, and the tangent 310 thus defines an inlet to the TAD 200. Such a configuration is shown, for example, FIG. 2 of the present invention and in U.S. Pat. No. 6,398,916 assigned to Metso Paper Karlstadt AB, also the assignee of the present invention. More particularly, FIGS. 1 and 2 of the '916 patent show a fabric transporting the web substantially vertically downward from the forming wire to the tangent at the cylinder. Once the fabric 150 is received by the cylinder 300 at the tangent 310, the fabric 150 and the web 50 wrap about the cylinder 300, such that the web 50 is dried by the air provided through the hood 400. The fabric 150 and the web 50 are then separated from the cylinder 300 at an outlet 320. The outlet 320 may also be defined by a tangent to the cylinder 300 or, in some instances, between an outlet roll 330 and the cylinder 300, wherein the outlet roll 330 is disposed adjacent to the cylinder 300 downstream, with respect to the rotational direction 350, of the inlet 310. The angular distance between the inlet 310 and the outlet 320 thereby defines a wrap angle 340 of the fabric 150 about the cylinder 300.

As shown in FIG. 1, embodiments of the present invention employ an inlet roll 360 disposed adjacent to the cylinder 300 and defining an increased-wrap inlet 370 to the TAD 200. The inlet roll 360 is disposed upstream of the tangent 310 with respect to the rotational direction 350 of the cylinder 300, wherein the tangent 310 is defined by the engagement between the fabric 150 and the cylinder 300 in the absence of the inlet roll 360. That is, the inlet roll 360 is disposed against the rotational direction from the tangent 310 so as to be laterally spaced from the transfer device 610 and/or the molding device 620, and inwardly with respect to the cylinder 300. The web 50 and fabric 150 are thus brought into contact with the cylinder 300 upstream of the tangent 310 with respect to the rotational direction 350, thereby increasing the wrap angle 340 of the fabric 150 about the cylinder 300. By increasing the wrap angle 340 of the fabric 150 about the cylinder 300, several advantages may be realized. For example, under the same operational conditions as a TAD 200 lacking the inlet roll 360, increased drying of the web 50 may be obtained by the configuration using the inlet roll 360. The increased drying provided by the increased wrap angle 340 may also allow the rotational speed of the TAD 200 to be increased. Alternatively, the same amount of drying of the web 50 as a TAD 200 lacking the inlet roll 360 may be obtained by the configuration using the inlet roll 360 using a decreased air flow through the hood 400. The decreased air flow through the hood 400 may thereby reduce energy consumption for the through-air drying process. Still further, a smaller cylinder 300 may be employed by the configuration using the inlet roll 360 so as to provide a more compact and less costly drying section 100.

In the embodiment shown in FIG. 1, the inlet roll 360 is disposed with respect to the inward flow TAD 200 so as to comprise a sheet-side or web-contacting roll, in instances where the web 50 is supported by a single TAD fabric 150. Such a configuration is advantageous, for instance, when the TAD 200 is the first or initial dryer in the drying section 100 following the forming section, when the web 50 is still relatively wet. More particularly, at the initial dryer, the web 50 may be equal to or less than about 40% dry solids content and, in some instances, equal to or less than about 20% dry solids content. In such a wet state, the web 50 is generally fragile and may be easily damaged. As such, prior art drying sections generally avoid contact with the web 50 prior to the web 50 being dried by the initial TAD 200. In other instances, prior art drying sections as shown, for example, in U.S. Pat. No. 3,432,936, are configured to initially dry the web 50 with a Yankee dryer before transferring the web 50 to the TAD 200, since the web 50 will be drier and thus have greater strength and less tendency for picking, as will be appreciated by one skilled in the art.

In contrast to these prior art drying sections, embodiments of the present invention employ an inlet roll 360 configured to contact the web 50 prior to the initial TAD 200 when the web 50 emerges from the forming section and is still relatively wet. Accordingly, embodiments of the present invention implement an inlet roll 360 having a low adhesive surface so as to prevent, reduce, or minimize adhesion of the wet web 50 to the inlet roll 360 prior to the web 50 being dried by the initial TAD 200. For example, the inlet roll 360 may include a chrome-plated surface for providing the low adhesive characteristic for the inlet roll 360, though one skilled in the art will appreciate that the low adhesive surface may be provided in other manners such as, for instance, by a PTFE-impregnated ceramic matrix coating, a PTFE or other low adhesive plasma coating, or other suitable coating. In some instances, a doctor blade (not shown) or other separating device may be provided in operable engagement with the inlet roll 360, after the web 50 and fabric 150 have advanced through the increased-wrap inlet 370, so as to ensure that the web 50 does not adhere to the inlet roll 360 (continuously cleans the surface of the inlet roll 360 so as to prevent any residue accumulation on the inlet roll 360 that could cause the web 50 to stick to the surface of the inlet roll 360) and that the web 50 follows the fabric 150 about the cylinder 300 (prevent the web 50 from following or wrapping around the inlet roll 360). Still other embodiments may employ a second TAD fabric (not shown) configured to engage the web 50 opposite to the initial TAD fabric 150 prior to the inlet roll 360, and to be advanced about the cylinder 300 in engagement with the web 50 through the outlet 320, such that contact between the inlet roll 360 and the web 50 is avoided.

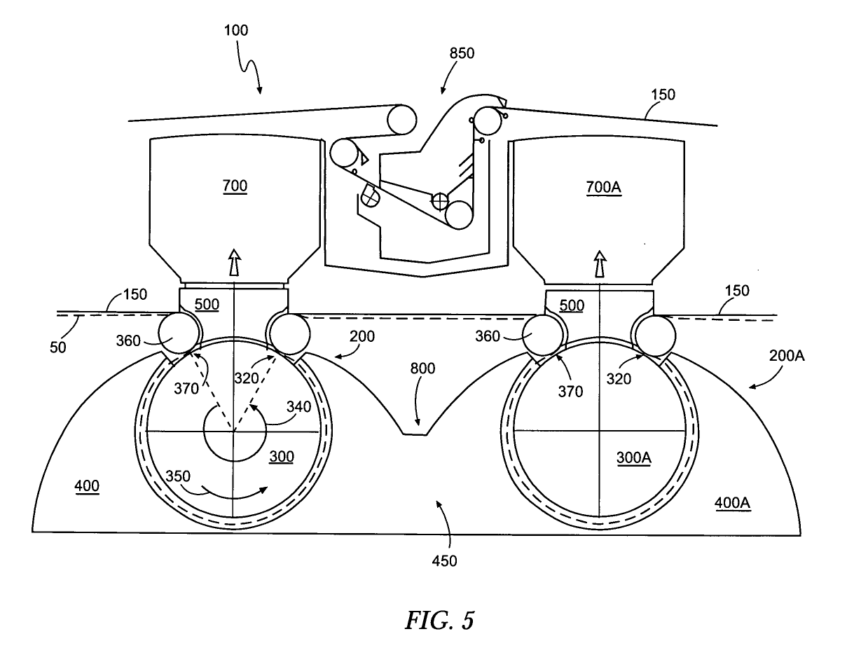

Embodiments of the present invention employing an inlet roll 360 provide further advantages, particularly in instances where the cylinder 300 is engaged from below by the hood 400. For example, the use of the inlet roll 360 to provide the increased-wrap inlet 370 allows the web receiving point 600 to be laterally spaced outward from the cylinder 300 and/or the hood 400 since the wrap angle 340 is no longer determined by the location of the tangent 310 to the cylinder 300. As such, since the web receiving point 600 is laterally separated from the increased-wrap inlet 370, the TAD 200 may be less susceptible to contamination from, for example, water dripping or otherwise emitted from the web 50 about the web receiving point 600, water from the molding device 620, or web stock or trim shed by the web 50 as it is transported to the TAD 200. Such contamination may be an issue in instances such as shown in FIGS. 1 and 2 of U.S. Pat. No. 6,398,916 where the web is transported by the fabric generally vertically downward from the web receiving point into the TAD. Accordingly, laterally spacing the web receiving point 600 from the increased wrap inlet 370 advantageously provides that any such contamination could be collected in a suitable catch pan or other appropriate receptacle located at a convenient point in the drying section 100, or other structure supporting the TAD 200, thereby simplifying cleaning procedures. Further, in embodiments of a drying section 100 using two or more TADs, as shown in FIG. 5, the initial TAD 200 using the inlet roll 360 may be configured to be substantially identical to the successive downstream TAD(s), such as second TAD 200A, since a particular tangent 310 (and thus an appropriately configured TAD) for providing the necessary wrap angle 340 is not required when the inlet roll 360 is implemented. In such instances, engineering requirements may be simplified and costs may be reduced.

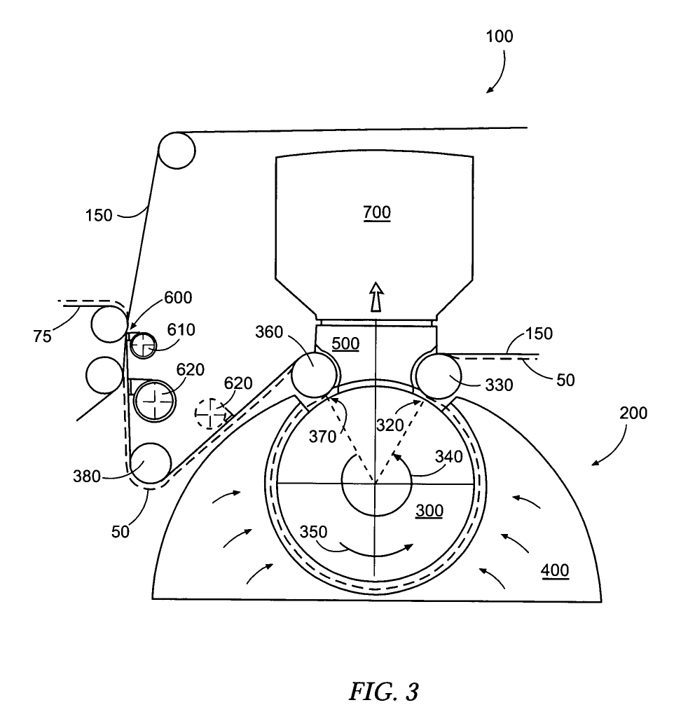

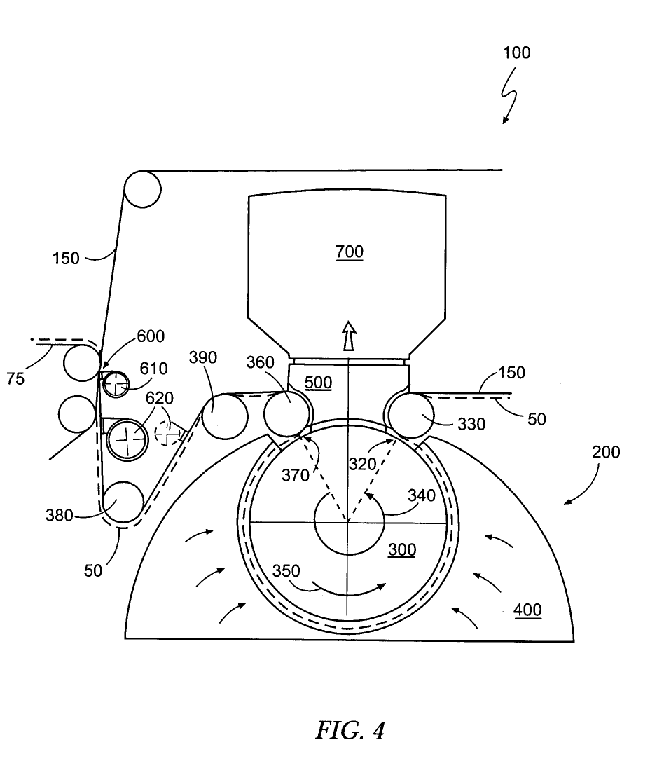

Other embodiments of the present invention implementing an inlet roll 360, as shown, for example, in FIGS. 3 and 4, may provide further advantages, particularly in instances where the cylinder 300 is engaged from below by the hood 400. For example, any or all of the web receiving point 600, the transfer device 610, and the molding device 620 may be lowered with respect to the TAD 200, thereby reducing the need for an elevated former or forming section, which may be undesirable in terms of machine and building costs and operator access. That is, the former, the forming section, and/or the web receiving point 600 may be lowered to a “ground level” or on the same level as the TAD 200 by using one or more fabric-side rolls 380, 390 to guide the fabric 150 and the web 50 to the inlet roll 360. Such a configuration may also advantageously provide a more compact machine. In some instances, the fabric-side roll(s) 380, 390 may allow the molding device 620 to be moved further downstream of transfer device 610 such that, for instance, one of the fabric-side rolls 380 is disposed therebetween, as shown in FIG. 4. In such an instance, the fabric-side roll 380 may serve to partially dewater the web 50 and/or to allow any stray web stock or trim to be shed from the web 50 prior to the web 50 being subjected to the molding device 620, thereby possibly reducing the instances of defects or contamination in the molded web 50 and/or reducing the energy consumption of the molding device 620. In some cases, the fabric side roll 380 may be provided with other components, such as a doctor blade and associated catch pan or other receptacle, so as to remove and collect any contamination from the fabric side roll 380 and facilitate a more efficient operation.

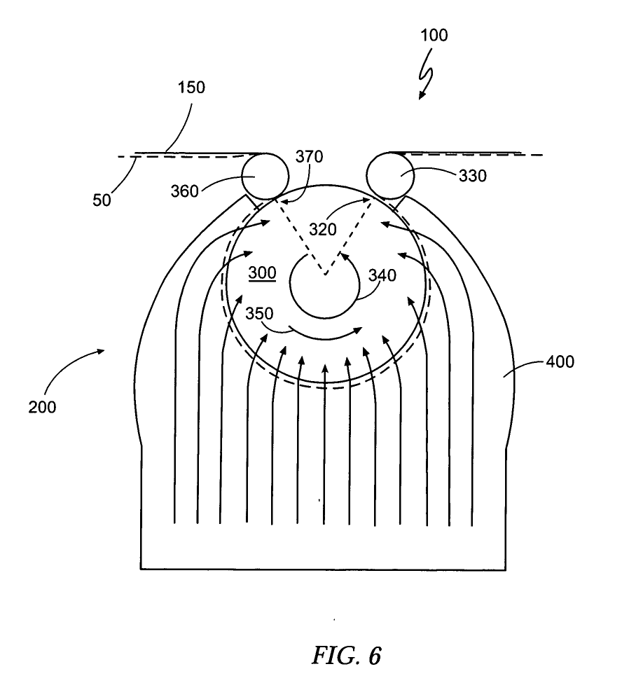

Another advantageous aspect of the present invention involves the configuration of the hood 400 for the TAD 200 as shown, for example, in FIGS. 1-5. More particularly, embodiments of the present invention may employ a hood 400 having a contoured profile and configured to extend about the portion of the shell or circumference of the cylinder 300 over which the fabric 150 is engaged, as particularly illustrated in FIG. 6. As shown, the hood 400 engages the cylinder 300 from underneath and extends up around the circumference of the cylinder 300. In doing so, the hood 400 may be curved or otherwise contoured about the cylinder 300 so as to direct and distribute the air flow provided through the hood 400 in a substantially uniform and consistent manner to the portion of the circumference of the cylinder 300 along the wrap angle 340 of the fabric 150. That is, due to the contoured profile of the hood 400, the air supplied by the hood 400 (internal flow) provides an air flow toward the cylinder 300 that is substantially uniform and consistent along the length of the fabric 150 and web 50 engaged with and being advanced about the portion of the circumference of the cylinder 300 in the machine direction between the increased-wrap inlet 370 and the outlet 320. As shown in FIG. 6, for example, the sides of the hood 400 arcuately taper toward the cylinder 300 as the hood 400 extends about the cylinder 300. That is, where the TAD 200 employs both an inlet roll 360 and an outlet roll 330, the sides of the hood 400 may be configured to arcuately taper as they extend about the cylinder 300 to the respective one of the inlet roll 360 and the outlet roll 330. The contoured profile of the hood 400 may have further advantages related to the configuration of the outer surface thereof, in addition to the advantages of improved internal air flow. More particularly, the contoured profile of the outer surface of the hood 400 may, for example, provide less opportunity for contamination to collect on the exterior of the hood 400, facilitate cleaning of the exterior of the hood 400, and facilitate accessibility to the TAD 200. In some instances, the contoured profile of the hood 400 may be aerodynamically configured where, for example, the profile of the hood 400 could be optimized such that air movement created by the moving web 50/fabric 150 may assist in removing contaminants from the exterior of the hood 400 or assist in preventing contamination from collecting on the exterior of the hood 400.

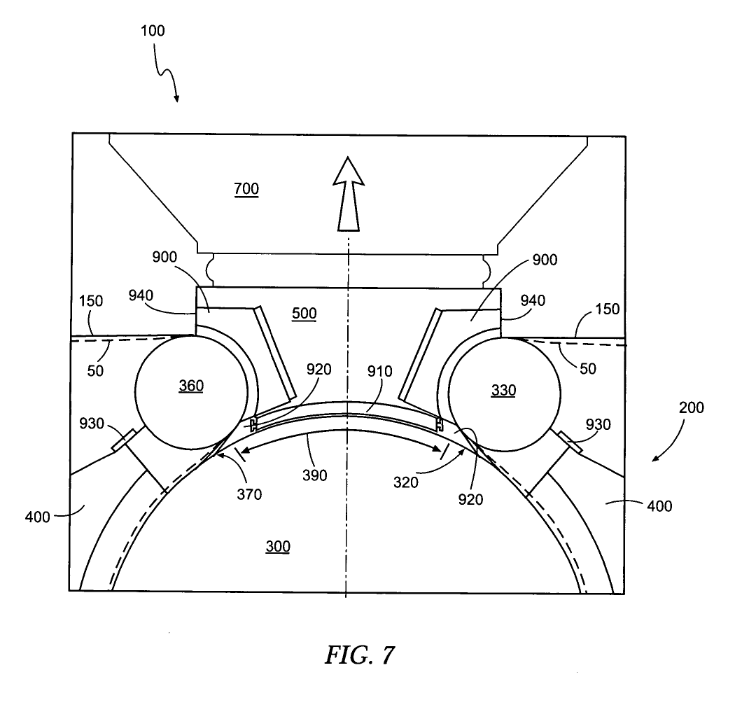

In instances where the TAD 200 employs both an inlet roll 360 and an outlet roll 330, the TAD 200 may further include hood-to-roll seals 930 sealingly engaging the respective roll 360, 330 and mounted to the frame (not shown) supporting the respective roll 360, 330, as shown in FIG. 7, so as to prevent or minimize leakage of the air supplied through the hood 400 from the TAD 200 and thus optimize the flow of air for drying the web 50. The seals 930 further extend toward the hood 400 so as to form a seal therewith. The sealing relation with the hood 400 may be accomplished by, for example, an impermeable flexible fabric. Alternatively, the hood-to-roll seals 930 may be engaged with the hood 400 so as to extend from the hood 400 to each of the inlet roll 360 and the outlet roll 330. The hood-to-roll seals 930 may be pivotably or removably engaged with the roll frame or the hood 400 so as to facilitate, for example, repair, replacement, or maintenance procedures with respect to the TAD 200. If necessary or desirable, the hood-to-roll seals 930 may be deformable or pivotable so as to minimize or prevent damage to the hood 400, the respective roll 360, 330, the roll frame, or other components if, for instance, the web 50 fails to follow the fabric 150 or other contamination inadvertently enters the TAD 200. In other instances, the hood 400 may also include air distribution provisions, such as vanes, diffusers, deflectors, or the like, extending laterally and/or in the machine direction along the hood 400 so as to facilitate air flow that is substantially even and consistent about and/or across the cylinder 300, wherein such air distribution provisions are preferably readily adjustable. Such a contoured hood configuration (and/or a hood 400 including air distribution provisions) may advantageously provide, for instance, a TAD 200 with substantially uniform internal air flow and drying characteristics about and/or across the cylinder 300, which may also facilitate simpler engineering, more efficient design, and lower costs associated with the machine.

In some embodiments of the present invention, the inlet roll 360 and the outlet roll 330 may be symmetrically disposed about a vertical plane extending through a lateral cross-section of the cylinder 300. Accordingly, since the inlet 370 and the outlet 320 are symmetric about the cylinder 300, the hood 400 may also be symmetric about the vertical plane. Further, the inlet roll 360 and the outlet roll 330 may also be spaced apart about the circumference of the cylinder 300 so as to form an angular gap or dead zone 390 therebetween. Since the fabric 150 is configured to transport the web 50 through the increased-wrap inlet 370 and through the wrap angle 340 about the cylinder 300 to the outlet 320, the angular gap or dead zone 390 is not engaged by the fabric 150 during the drying process. Thus, such embodiments may further include an exhaust plenum 500 operably engaged with the cylinder 300 across the angular gap 390 so as to exhaust or remove the air flow from the hood 400, after the air flow has provided the necessary drying of the web 50. This may also be referred to as a cross-flow configuration for the TAD 200. That is, after the air flow from the hood 400 has passed through the web 50, the fabric 150, and the perforations in the cylinder 300, to the interior of the cylinder 300, the moisture-laden air must be exhausted from the TAD 200. In such instances, the exhaust plenum 500 is configured to direct the moisture laden air through the perforations in portion of the cylinder 300 exposed to the angular gap 390. In an axial flow TAD configuration, the angular gap 390 is sealed, for example, by a sealing member (not shown), since the exhaust air is removed axially along the cylinder 300. A cross-flow configuration may be advantageous in some instances, as compared to exhausting the air axially along the cylinder 300 (axial flow), by providing more uniform drying in the lateral direction across the cylinder 300 (and thus across the width of the web 50). A cross-flow configuration may also facilitate ready access to the TAD 200 and may be a lower cost option since no internal components are required within the cylinder 300. In addition, the aspect ratio of the cylinder 300 may vary greatly without adversely affecting air distribution. However, such advantages do not preclude, in any manner, the application of the principles described herein to an axial-flow TAD configuration.

Once the exhaust air is directed away from the cylinder 300 by the exhaust plenum 500 in a cross-flow TAD configuration, the exhaust air may be collected by one or more exhaust ducts 700, 700A for directing the exhaust air away from the TAD 200. In axial flow TAD arrangements, appropriate exhaust components are operably engaged with one or both end of the cylinder 300, as will be appreciated by one skilled in the art. The exhaust air may be directed by the exhaust ducts 700, for instance, to be vented to atmosphere or to be recycled through appropriate devices (to remove the excess moisture or otherwise condition the air) before being directed back to the TAD 200 or other machine processes. One advantage of such a configuration of the exhaust plenum(s) 500 and exhaust duct(s) 700, 700A, as described herein, is that the nature of the configuration places the exhaust plenum(s) 500 and exhaust duct(s) 700, 700A within the loop of the fabric 150, which may help to reduce the overall height and/or size of the drying section 100 and/or papermaking machine and thereby provide a more compact device. As shown in FIG. 2, such an exhaust plenum 500 may, in some instances, be applied to an initial TAD 200 lacking an inlet roll 360. That is, when the initial TAD 200 lacks an inlet roll 360 and thus enters the TAD 200 at a tangent 310, the exhaust plenum 500 may be configured to extend about the dead zone 390 between the outlet roll 330 and the tangent 310. In such instances, appropriate sealing would also be provided such as, for example, a non-contacting hood-to-web seal sufficient to seal the hood having a pressure slightly above atmospheric pressure, and a plenum-to-fabric seal sufficient to seal the plenum having a pressure below atmospheric pressure. Such a configuration may, for example, advantageously minimize the risk of contamination entering the TAD 200.

Other advantageous aspects of the present invention may also be realized in instances where the drying section 100 includes more than one TAD 200, such as the two successive adjacent TADs 200, 200A shown in FIG. 5, and the TADs 200, 200A each include an inlet roll 360 and a contoured hood 400, 400A. In such instances, the amount of drying of the web 50 provided by each TAD 200, 200A may be less than, equal to, or greater than the amount of drying provided by a single TAD drying section 100. However, as the fabric 150 transports the web 50 from the exit 320 of the first TAD 200 to the inlet 370 of the following TAD 200A, water and/or web stock or trim may be shed from the web 50 and/or fabric 150. Depending on, for example, the proximity of the second TAD 200A to the initial TAD 200, this contamination may collect on the hoods for the respective TADs 200, 200A. Thus, in some instances, the contoured hoods 400, 400A of the adjacent TADs 200, 200A may cooperate and be operably engaged to define a gutter 800 extending transversely across the drying section 100 between the TADs 200, 200A, substantially perpendicularly to the direction of travel of the web 50/fabric 150. The gutter 800 may be appropriately configured to direct any contamination to one or both lateral sides of the drying section 100. That is, the gutter 800 formed by the hoods 400, 400A may define a slope directed toward one side of the drying section 100. In other instances, for example, the gutter 800 may have a raised medial portion, with respect to the lateral plane of the drying section 100, sloping toward both sides of the drying section 100. Accordingly, any contamination washed from the hoods 400, 400A or otherwise collected in the gutter 800 will be directed off to one or both sides of the drying section 100, thereby simplifying cleaning and maintenance thereof. In other instances, the adjacent cylinders 300, 300A may include a single hood 450 configured to be contoured about the cylinders 300, 300A, as with individual hoods 400, 400A, wherein the single hood 450 may also be configured to integrally define the gutter 800 as previously described.

Once the TAD fabric 150 has transported the web 50 through the TAD 200, the dried web 50 is typically separated from the fabric 150 and directed to further processes downstream. For example, the web 50 may be directed to a Yankee dryer, transferred to a transfer belt, or directed to a reel-up. After the web 50 is separated from the fabric 150, the fabric 150 must again proceed back to the web receiving point 600 since the fabric 150 is configured in a loop. However, the open weave nature of the TAD fabric 150 may cause residue from the web 50 to collect on the fabric 150 during the drying process (for example, web resin that cures on the fabric 150 during the drying process), thereby possibly shortening the service life of the fabric 150 and/or introducing defects into the web 50 and lowering the quality of the web 50. That is, contamination of the fabric 150 tends to reduce the porosity of the fabric 150 at the contaminated location, thereby adversely affecting drying of the web 50 by reducing the air flow therethrough. If such a condition occurs, the papermaking machine typically must be shut down and the fabric 50 cleaned manually, thereby resulting in costly down-time. Accordingly, in one embodiment of the present invention, the drying section 100 may further include a fabric-conditioning apparatus 850 for cleaning, dewatering, and/or otherwise conditioning the fabric 150. The fabric-conditioning apparatus 850 is disposed about the loop such that the fabric 150 is cleaned and conditioned after the web 50 has been separated from the fabric 150, but before the fabric 150 is advanced back to the web receiving point 600. The fabric 150 may, in some instances, have particular characteristics that affect the quality of the web 50. For example, the web-contacting surface of the fabric 150 may be sanded, which may affect, for instance, the quality of the web 50, the performance characteristics of the drying section 100, and/or the process parameters of subsequent process steps. In such instances, the fabric 150 may require careful handling during the conditioning process in order to prevent or minimize wear to the sanded surface. Wear of the sanded surface may undesirably cause, for example, the contact area between the fabric 150 and the web 50 to increase. Accordingly, embodiments of the present invention may further comprise a fabric-conditioning apparatus 850 as disclosed, for example, in U.S. patent application Ser. No.______ , entitled “Apparatus for Conditioning a Fabric in a Papermaking Machine and Associated Method,” assigned to Metso Paper Karlstadt AB, also the assignee of the present invention, and filed concurrently herewith. The advantages of such a fabric-conditioning apparatus 850 are disclosed in the referenced patent application, which is incorporated herein by reference. In embodiments including two successive adjacent TADs 200, 200A, as shown in FIG. 5, the fabric-conditioning apparatus 850 may be disposed, for example, between the adjacent exhaust ducts 700, 700A of the TADs 200, 200A. Such a configuration may be advantageous, for instance, to provide a more compact drying section 100 and/or papermaking machine. Further, any cleaning fluid that may escape from the fabric-conditioning apparatus 850 will be more likely to collect in the gutter 800 and thus be directed outwardly of the drying section 100 so as to reduce or minimize contamination and facilitate maintenance.

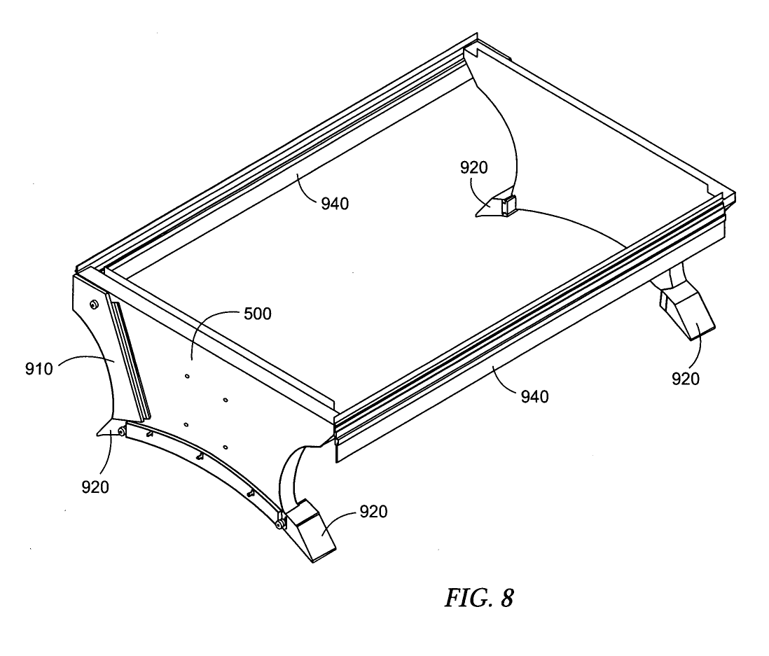

With respect to cross-flow TAD 200 employing an exhaust plenum 500, as previously described, it may be advantageous for the exhaust plenum 500 to be sealed about the dead zone 390 such that the exhaust follows the desired path to be removed from the drying section 100 or to be recirculated to the TAD 200 or other processes. Thus, as shown in FIGS. 7 and 8, the exhaust plenum 500 may further include one or more seals operably engaged between the exhaust plenum 500 and the TAD 200. Such seals may include, for example, plenum-to-roll seals 900 disposed between the plenum 500 and each of the inlet roll 360 and the outlet roll 330, toward the opposing cross-machine sides of the respective roll 360, 330, so as to minimize exhaust leakage between the plenum and the respective roll 360, 330. The plenum-to-roll seals 900 may be adjustably mounted to the plenum 500 so as to the distance between the seals 900 and the rolls 360, 330 to be optimized. In some instances, the seals 900 may be adjustable in the cross-machine direction. Such seals 900 may be configured to engage the fabric 150 passing about the rolls 360, 300, or to engage the rolls 360, 330 themselves. In certain advantageous instances, the plenum-to-roll seals 900 may be engaged with the plenum 500, for example, through a hinge connection or may be otherwise removable from the plenum 500 so as to facilitate, for instance, fabric change and inspection procedures. Plenum-to-TAD cylinder seals 910 may also be provided at opposite cross-machine sides of the plenum 500 so as to be engaged between the plenum 500 and the cylinder 300 and thereby minimize exhaust leakage therebetween. The plenum-to-TAD cylinder seals 910 may be adjustable with respect to its engagement with the cylinder 300. Plenum-to-fabric seals 920 are disposed about the outside corners of the plenum 500 and, in cooperation with the plenum-to-roll seals 900 and the plenum-to-TAD cylinder seals 910, provide sealing between the plenum 500, the cylinder 300, and the fabric 150 passing about the inlet roll 360 and the outlet roll 330, or between the plenum 500, the cylinder 300, and the rolls 360, 330 themselves. The plenum-to-fabric seals 920 may be adjustable in the cross-machine direction.

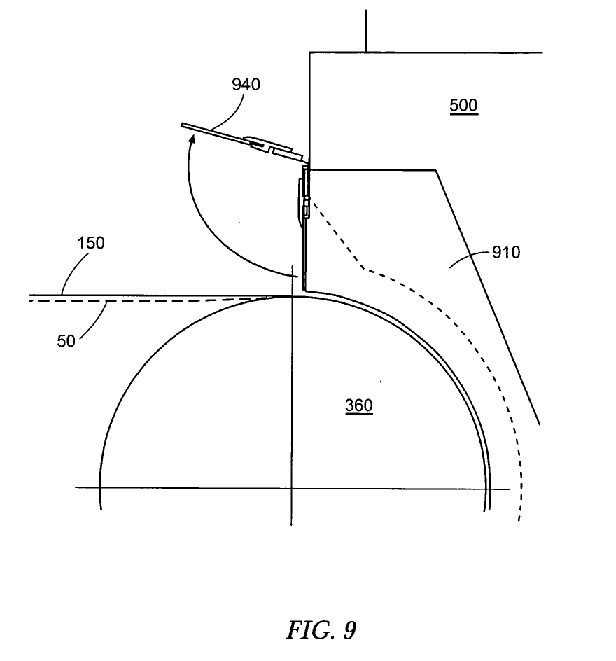

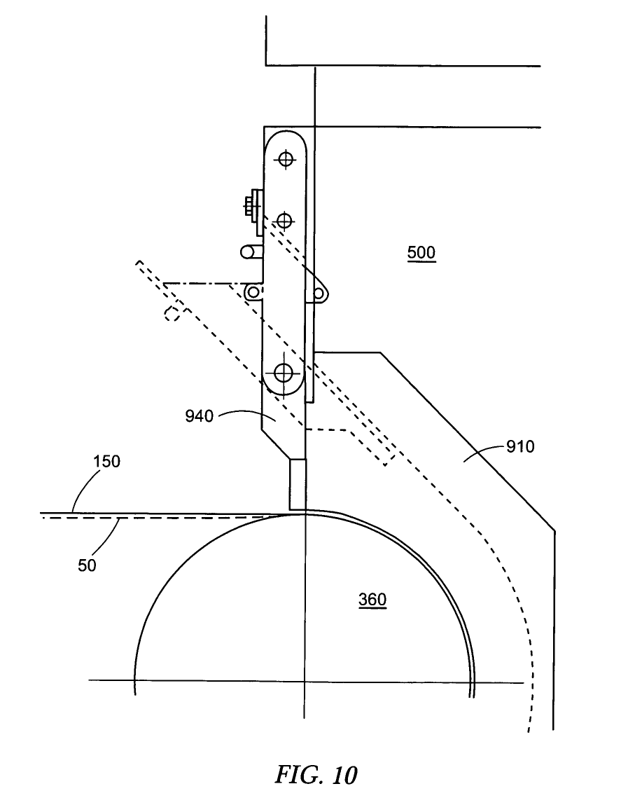

As shown in FIGS. 7-10, cross-machine plenum seals 940 may also be provided. Such seals 940 are operably engaged with the cross-machine sides of the plenum 500 and extend to the fabric 150 passing about each of the inlet roll 360 and the outlet roll 330 so as to minimize exhaust leakage in the area between the plenum 500 and the respective rolls 360, 330. The cross-machine plenum seals 940 may be contiguous across the plenum (in the cross-machine direction), or any of the seals 940 may be segmented. In some instances, redundant cross-machine plenum seals 940 may be provided, if necessary or desirable. As shown, the cross-machine plenum seals 940 may, in some instances, be pivotably mounted to the plenum 500, as shown more particularly in FIGS. 9 and 10, so as to, for example, facilitate fabric change and maintenance procedures. In other instances, however, the cross-machine plenum seals 940 may be configured to be removable from the plenum 500. During operation of the TAD 200, the cross-machine plenum seals 940 may be required to be in a fixed position. Accordingly, the pivotable or removable seals 940 may also include provisions for maintaining the seals 940 in a stationary position during operation of the TAD 200. However, there may be occurrences where contamination, such as web residue, may collect on the fabric 150, on the side opposite the web 50, and either enter or exit the TAD 200 by the cross-machine plenum seals 940. As such, in some instances, the cross-machine plenum seals 940 may also be configured to be deformable or pivotable so that the seals 940 yield to such contamination, thereby preventing or minimizing damage to the plenum 500 or other components. For example, a deformable cross-machine plenum seal 940 may employ a soft aluminum as the seal material. One skilled in the art will also appreciate that the seal arrangements described herein may also be applicable to a sealing member used in an axial flow TAD configuration, in place of the plenum 500 in a cross-flow TAD configuration, as described herein.

Many modifications and other embodiments of the inventions set forth herein will come to mind to one skilled in the art to which these inventions pertain having the benefit of the teachings presented in the foregoing descriptions and the associated drawings. For example, the fabric-conditioning apparatus 850 may include provisions for deflecting or collecting any cleaning fluid leaking therefrom towards the sides of the machine such that the fluid does not wet or contaminate the fabric 150 and/or the web 50. Such deflecting or collecting provisions may also be advantageous when the fabric-conditioning apparatus 850 is periodically washed or otherwise cleaned. Further, U.S. Pat. No. 6,199,296 to Jewitt discusses principles related to sealing for through-air dryers and, as such, some of the principles discussed in the '296 patent may be applied to embodiments of the present invention, as discussed herein. One skilled in the art will also appreciate that, although the configuration of the fabric-conditioning apparatus 850 shown and described herein is implemented in a substantially vertical orientation, the concept may also be implemented in a substantially horizontal orientation. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A drying section for a papermaking machine, comprising:
an initial dryer adapted to provide initial drying of a wet paper web entering the drying section, the initial dryer comprising a drying cylinder rotatable in a rotational direction and having opposed ends;
a fabric configured to receive the web at a web receiving point and to advance the web at least partially about the cylinder over an angular distance in the rotational direction from an inlet to an outlet, the angular distance between the inlet and the outlet defining a wrap angle of the fabric;
an inlet roll disposed adjacent to the cylinder so as to define the inlet, the inlet roll further being disposed upstream, with respect to the rotational direction, from a tangent to the cylinder, the tangent being defined by an engagement between the fabric and the cylinder absent the inlet roll, so as to increase the wrap angle of the fabric about the cylinder of the initial dryer with respect to the tangent.

2. A drying section according to claim 1 wherein the drying cylinder further comprises a through-air drying cylinder configured for an inward air flow in an inward flow through-air dryer.

3. A drying section according to claim 1 wherein the fabric is configured to be disposed between the web and the cylinder, and the inlet roll is configured to contact the web at the inlet.

4. A drying section according to claim 1 wherein the inlet roll includes a low-adhesive surface.

5. A drying section according to claim 1 wherein the inlet roll includes a chrome-plated surface.

6. A drying section according to claim 1 further comprising a hood configured to extend over at least a portion of the cylinder engaging the fabric and to provide an inward air flow with respect to the cylinder, the hood having a contoured profile configured to direct a substantially even air flow into the cylinder along the portion of the cylinder covered by the hood.

7. A drying section according to claim 6 wherein the contoured profile hood includes opposing sides configured to arcuately taper toward the cylinder as the sides extend about the cylinder.

8. A drying section according to claim 1 further comprising a second dryer disposed downstream of and adjacent to the initial dryer, the second dryer comprising a drying cylinder, at least a portion of each cylinder engaging the fabric being covered by a hood having a contoured profile, the hoods cooperating so as to define a gutter therebetween.

9. A drying section according to claim 1 further comprising an outlet roll disposed adjacent to the cylinder downstream of the inlet roll in the rotational direction, the fabric and the web being configured to be advanced between the outlet roll and the cylinder such that the outlet roll contacts the web.

10. A drying section according to claim 9 further comprising a hood configured to extend about at least a portion of the cylinder engaging the fabric, between the inlet roll and the outlet roll, the hood having a contoured profile.

11. A drying section according to claim 9 further comprising a sealing member configured to extend about at least a portion of the cylinder not engaging the fabric, between the inlet roll and the outlet roll, a seal extending between the sealing member and the fabric being advanced about each of the inlet and outlet rolls, and an exhaust plenum operably engaged with at least one end of the cylinder.

12. A drying section according to claim 9 further comprising an exhaust plenum configured to extend about at least a portion of the cylinder not engaging the fabric, between the inlet roll and the outlet roll.

13. A drying section according to claim 12 further comprising a seal extending between the exhaust plenum and the fabric being advanced about each of the inlet and outlet rolls.

14. A drying section according to claim 13 wherein at least one of the seals is configured to be pivotably mounted to the exhaust plenum.

15. A drying section according to claim 13 wherein at least one of the seals is configured to be deformable.

16. A drying section according to claim 1 wherein the web receiving point is laterally displaced from the inlet roll.

17. A drying section according to claim 1 further comprising a doctor blade operably engaged with the inlet roll downstream of the inlet.

18. A drying section for a papermaking machine, comprising:
a fabric adapted to support a wet paper web;
an initial drying cylinder rotatable in a rotational direction and having opposed ends, the cylinder being configured to have the fabric advanced at least partially thereabout; and
a hood configured to surround at least a portion of the cylinder engaging the fabric and to provide an inward air flow with respect to the cylinder, the hood having a contoured profile configured to direct a substantially even air flow into the cylinder along the portion of the cylinder covered by the hood.

19. A drying section according to claim 18 further comprising an inlet roll disposed adjacent to the cylinder in an upstream direction and an outlet roll disposed adjacent to the cylinder in a downstream direction, both with respect to the rotational direction, the fabric being advanced in the rotational direction over an angular distance about the cylinder and between the respective inlet and outlet rolls and the cylinder, the hood extending between the inlet and outlet rolls and the angular distance defining a wrap angle of the fabric.

20. A drying section according to claim 19 further comprising a sealing member configured to extend about at least a portion of the cylinder not engaging the fabric, between the inlet roll and the outlet roll, a seal extending between the sealing member and the fabric being advanced about each of the inlet and outlet rolls, and an exhaust plenum operably engaged with at least one end of the cylinder.

21. A drying section according to claim 19 further comprising an exhaust plenum configured to extend about at least a portion of the cylinder not engaging the fabric, between the inlet roll and the outlet roll.

22. A drying section according to claim 21 further comprising a seal extending between the exhaust plenum and the fabric about each of the inlet and outlet rolls.

23. A drying section according to claim 22 wherein at least one of the seals is pivotably mounted to the exhaust plenum.

24. A drying section according to claim 22 wherein at least one of the seals is configured to be deformable.

25. A drying section according to claim 19 wherein the inlet roll is disposed upstream with respect to the rotational direction from a tangent to the cylinder, the tangent being defined by an engagement between the fabric and the cylinder in the absence of the inlet roll, so as to increase the wrap angle of the fabric about the cylinder with respect to the tangent.

26. A drying section according to claim 25 wherein the inlet roll includes a low adhesive surface.

27. A drying section according to claim 18 further comprising a second drying cylinder disposed downstream of and adjacent to the initial drying cylinder, at least a portion of each cylinder engaging the fabric being covered by a hood having a contoured profile, the hoods cooperating so as to define a gutter therebetween.

28. A method of drying a wet paper web in a drying section of a papermaking machine, comprising:
directing a fabric supporting the wet paper web toward an initial dryer configured to provide initial drying of the web upon the web entering the drying section, the initial dryer comprising a drying cylinder rotatable in a rotational direction;
advancing the web and the fabric at least partially about the cylinder over an angular distance in the rotational direction from an inlet to an outlet, the angular distance between the inlet and the outlet defining a wrap angle of the fabric;
advancing the web and the fabric through the inlet prior to advancing the web and the fabric about the cylinder, the inlet being defined by a web-contacting inlet roll disposed adjacent to the cylinder and upstream, with respect to the rotational direction, from a tangent to the cylinder, the tangent being defined by an engagement between the fabric and the cylinder absent the web-contacting inlet roll, the inlet provided by the web-contacting inlet roll thereby increasing the wrap angle of the fabric about the cylinder with respect to the tangent.

29. A method according to claim 28 further comprising providing an air flow inwardly to the cylinder with a hood configured to extend over at least a portion of the cylinder engaging the fabric, the hood having a contoured profile configured to direct a substantially even air flow into the cylinder along the portion of the cylinder covered by the hood.

30. A method according to claim 28 wherein directing a fabric toward an initial dryer further comprises directing the fabric supporting the wet paper web from a web receiving point toward the initial dryer, the web receiving point being laterally displaced from the inlet.

31. A method according to claim 28 further comprising separating the web from the web-contacting inlet roll with a doctor blade operably engaged with the web-contacting inlet roll downstream of the inlet.
